(19) United States
(12) Patent Application Publication
(10) Pub. No.: US 2026/0211356 A1
(43) Pub. Date: Jul. 23, 2026

(54) TONER CONTAINER AND IMAGE FORMING APPARATUS

(71) Applicant: KYOCERA Document Solutions Inc., Osaka (JP)

(72) Inventor: Danh Chien Nguyen, Osaka (JP)

(21) Appl. No.: 19/452,140

(22) Filed: Jan. 16, 2026

(30) Foreign Application Priority Data
Jan. 20, 2025 (JP) 2025-007485

(51) Int. Cl. G03G 15/08; G03G 21/16

(52) U.S. Cl. CPC G03G 15/0886; G03G 15/0875; G03G 15/0898; G03G 21/1647; G03G 2221/1654

(57) ABSTRACT

A toner container is detachably attached to an attachment target part of an image forming apparatus and includes a container body, a delivery port, a first shutter, and a second shutter. The first shutter is movable between a first close position to close the delivery port and a first open position to open the delivery port. The second shutter is arranged at a position farther from the delivery port than the first shutter in a delivery direction and is movable between a second close position to close the delivery port and a second open position to open the delivery port.

### INCORPORATION BY REFERENCE

This application is based upon and claims the benefit of priority from the corresponding Japanese Patent Application No. 2025-007485 filed on Jan. 20, 2025, the entire contents of which are incorporated herein by reference.

The present disclosure relates to a toner container and an image forming apparatus.

### BACKGROUND

As a related technology, a toner cartridge with a shutter is known. The toner cartridge includes a toner cartridge body that stores toner and a discharge port for supplying the toner stored in the toner cartridge body to the image forming apparatus. The toner cartridge further includes a single shutter. The shutter opens the discharge port when the toner cartridge body is attached to the image forming apparatus. The shutter closes the discharge port when the toner cartridge body is detached from the image forming apparatus.

### SUMMARY

A toner container according to an aspect of the present disclosure is detachably attached to an attachment target part of an image forming apparatus and includes a container body, a delivery port, a first shutter, and a second shutter. The container body that stores toner. The delivery port delivers the toner to an outside from an inside of the container body. The first shutter is movable between a first close position to close the delivery port and a first open position to open the delivery port. The second shutter is arranged at a position farther from the delivery port than the first shutter in a delivery direction in which the toner is delivered from the delivery port and is movable between a second close position to close the delivery port and a second open position to open the delivery port.

An image forming apparatus according to another aspect of the present disclosure includes the above-mentioned toner container; an attachment target part to which the toner container is attached; and a housing that houses the attachment target part.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

These and other objects, features and advantages of the present disclosure will become more apparent in light of the following detailed description of best mode embodiments thereof, as illustrated in the accompanying drawings.

### BRIEF DESCRIPTION OF FIGURES

FIG. 1 is a schematic view showing a configuration of an image forming apparatus according to an embodiment.

FIG. 2 is a schematic perspective view showing an outer appearance of a toner container and a developing apparatus according to the embodiment.

FIG. 3 is a schematic perspective view showing a configuration of the toner container according to the embodiment.

FIG. 4 is a schematic exploded perspective view showing main parts of the toner container according to the embodiment.

FIG. 5 is a schematic cross-sectional view showing main parts of the toner container according to the embodiment.

FIG. 6 is an explanatory view of open/close of a first shutter according to the embodiment.

FIG. 7 is an explanatory view of open/close of a second shutter according to the embodiment.

FIG. 8 is a schematic perspective view showing an outer appearance of the first shutter and a lock member according to the embodiment.

FIG. 9 is an explanatory view of a fixation method for the first shutter by the lock member according to the embodiment.

FIG. 10 is an explanatory view of a fixation canceling method for the first shutter by the lock member according to the embodiment.

FIG. 11 is an explanatory view of a motion of the first shutter and the second shutter when the toner container according to the embodiment is inserted into the attachment target part.

FIG. 12 is an explanatory view of a motion of the first shutter and the second shutter the toner container according to the embodiment is detached from the attachment target part.

### DETAILED DESCRIPTION

Hereinafter, an embodiment of the present disclosure will be described with reference to the accompanying drawings. The following embodiment is an example embodying the present disclosure and is not intended to limit the technical scope of the present disclosure.

### [1] OVERALL CONFIGURATION OF IMAGE FORMING APPARATUS

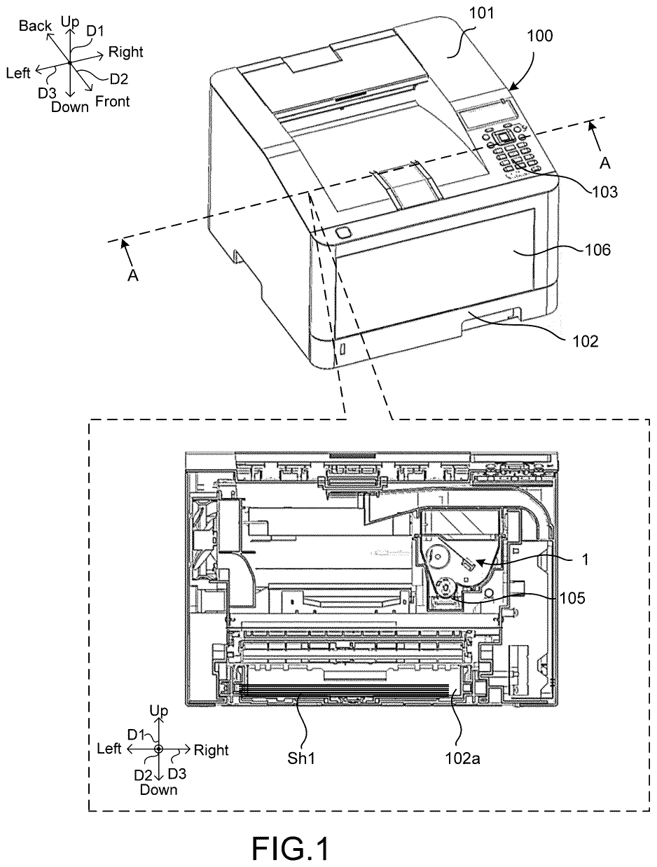

First of all, an overall configuration of an image forming apparatus 100 according to the present embodiment will be described with reference to FIG. 1. Hereinafter, for the sake of description, a vertical direction in an installed state (state shown in FIG. 1) in which the image forming apparatus 100 can be used is defined as up and down directions D1. Moreover, directions of the image forming apparatus 100 shown in FIG. 1, which are orthogonal to the sheet, are defined as front and back directions D2 and a surface on the front side in FIG. 1 is defined as front (front surface). Furthermore, defining a surface on the left side of the sheet of FIG. 1 as a left side surface, left and right directions D3 are defined. It should be noted that those direction definitions should not be interpreted as limiting the forms in which the image forming apparatus 100 is used.

As an example, the image forming apparatus 100 according to the present embodiment is a printer with a print function. It should be noted that the image forming apparatus 100 is not limited to the printer, and may be a multifunction peripheral with multiple functions, such as a print function, a scanner function, a facsimile function, and a copying function.

As shown in FIG. 1, the image forming apparatus 100 includes a housing 101, a paper feed part 102, an operation display part 103, and a toner container 1. In FIG. 1, the view surrounded by the broken line shows a cross-sectional view along the line A-A. Moreover, although it is not shown in the figure, the image forming apparatus 100 includes an image forming part and a control part. The paper feed part 102, the operation display part 103, the toner container 1, the image forming part, and the control part are all provided in the housing 101.

The paper feed part 102 feeds sheets Sh1 to the image forming part. The paper feed part 102 includes a sheet feed cassette 102a and a plurality of convey rollers (not shown), for example. The paper feed part 102 conveys each of the sheets Sh1 on a conveyance path from the sheet feed cassette 102a through the plurality of convey rollers and the like and feeds the sheet Sh1 to the image forming part. The image forming part forms an image on the sheet Sh1 fed on the conveyance path from the paper feed part 102.

The operation display part 103 is a user interface in the image forming apparatus 100. The operation display part 103 includes a display part such as a liquid-crystal display that displays various types of information in accordance with control instructions from the control part and an operation part such as a switch or touch panel that inputs various types of information in the control part in accordance with user's operations. Moreover, the image forming apparatus 100 may include, for example, an audio output part and an audio input part in addition to or instead of the operation display part 103 as a user interface. Moreover, the operation display part 103 may be, for example, an external device provided separately from the image forming apparatus 100. In this case, the image forming apparatus 100 can use the operation display part 103 as a user interface by executing data communication with an external device.

The toner container 1 stores toner as a developer for use in developing processing by a developing device 104 to be described later. In the present embodiment, the toner stored in the toner container 1 is K (black) toner. The toner container 1 supplies the stored toner to the image forming part in a state attached to an attachment target part 105 inside the housing 101. The toner container 1 will be described in detail in “[2] Configuration of toner container” to be described later.

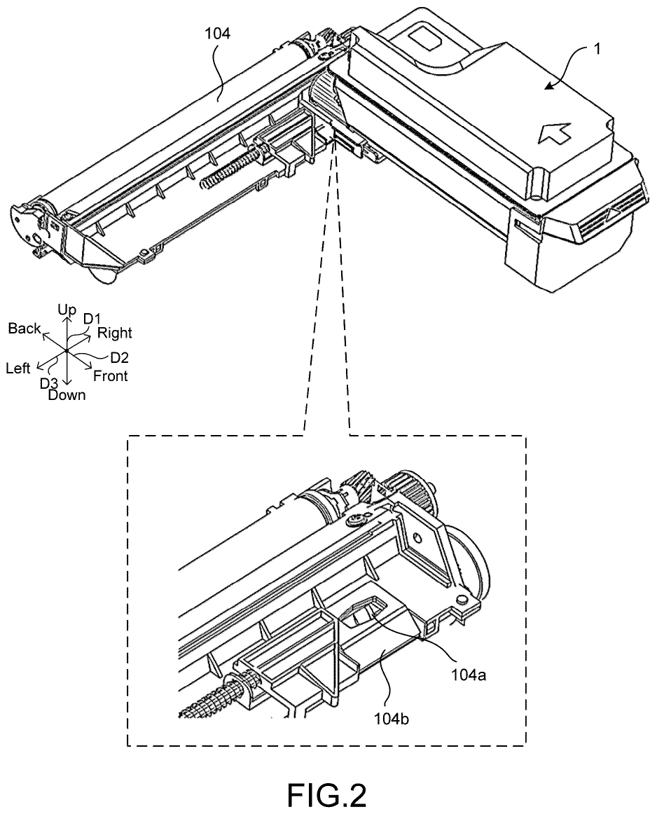

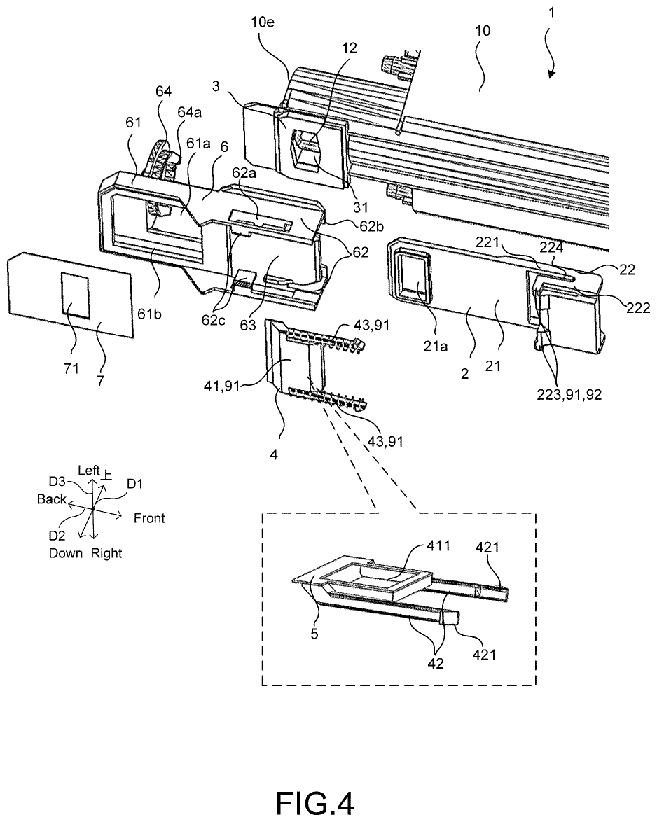

The attachment target part 105 is fixed to an inside frame inside the housing 101. The attachment target part 105 houses the toner container 1 and is configured to be capable of attaching the toner container 1 at an attachment position set inside the attachment target part 105. In the present embodiment, as shown in FIG. 2, the attachment position is a position where a replenishment port 104a of the developing device 104 and a delivery port 12 of the toner container 1 (see FIG. 4) to be described later face each other in the up and down directions D1. Moreover, the attachment target part 105 supports the toner container 1 to be slidable in the front and back directions D2.

It should be noted that a seal member 104b is bonded to a peripheral edge of the replenishment port 104a in the developing device 104. The seal member 104b is a thin film-shaped member. The seal member 104b is made of an elastic material, such as a silicon rubber, urethane, or sponge. The seal member 104b is arranged for absorbing toner sticking to the periphery of the replenishment port 104a.

An opening (not shown) is provided in a front end of the attachment target part 105. The opening is exposed to the outside of the image forming apparatus 100 by opening a cover 106 provided on a front surface of the image forming apparatus 100. Therefore, the user can attach the toner container 1 to the attachment target part 105 by inserting the toner container 1 rearward from the opening in a state in which the cover 106 is opened. Moreover, the user can detach the toner container 1 from the attachment target part 105 by moving the toner container 1 attached to the attachment target part 105 rearward in a state in which the cover 106 is opened.

It can be said that in a state in which the toner container 1 is attached to the attachment target part 105, the image forming apparatus 100 includes the toner container 1, the attachment target part 105 to which the toner container 1 is attached, and the housing 101 that houses the attachment target part 105.

On the basis of image data input from the information processing apparatus outside the image forming apparatus 100, such as a personal computer, the image forming part forms an image on the sheet Sh1. In the present embodiment, as an example, the image forming part includes a photosensitive drum (not shown), a charging device (not shown), the developing device 104 (see FIG. 2), a transferring device, and a fuser device, for example, and forms an image on the sheet Sh1 by an electrographic method. In the present embodiment, the image forming part has a configuration to form a monochrome image by using K (black) color. It should be noted that the image forming part may have a configuration to form a full-color image by using four colors of C (cyan), M (magenta), Y (yellow), and K (black).

The image forming part forms an image on the sheet Sh1 by using toner supplied from the toner container 1. Specifically, the image forming part forms an electrostatic latent image by irradiating the surface of the photosensitive drum charged by the charging device with laser light. Moreover, the image forming part forms a toner image on the surface of the photosensitive drum by the developing device 104 developing an electrostatic latent image with toner. Then, the image forming part in the transferring device transfers the toner image to the sheet Sh1 conveyed on the conveyance path. The fuser device fuses and fixes the toner image transferred to the toner image on the sheet Sh1. For example, the fuser device includes a fuser roller and a pressure roller, and fixes the toner image on the sheet Sh1 by heating the toner image transferred to the sheet Sh1 and pressurizing the toner image on the sheet Sh1.

The control part comprehensively controls the image forming apparatus 100. The control part uses a computer system including one or more processors and one or more memories as main configurations. In the image forming apparatus 100, the functions of the control part are realized by the one or more processors executing programs. The programs may be recorded in advance on the one or more memories. Alternatively, the programs may be provided via telecommunication lines, e.g., the Internet. Alternatively, the programs may be provided, recorded on a non-transitory recording medium readable by the computer system, e.g., a memory card or optical disc. The one or more processors are constituted by one or more electronic circuits including semiconductor integrated circuits. In addition, the computer system in the present disclosure includes a micro-controller including the one or more processors and the one or more memories. The control part may be a control part that is provided separately from a main control part that comprehensively controls the image forming apparatus 100.

Moreover, the image forming apparatus 100 further includes a storage part, a communication part, and a power supply part, for example. The storage part includes one or more nonvolatile memories. Information such as the control programs for causing the control part to execute various types of processing is prestored in the one or more nonvolatile memories. The communication part is an interface that executes data communication between the image forming apparatus 100 and an external device connected via a communication network, e.g., the Internet or a local area network (LAN). The power supply part is a power supply circuit that generates (outputs) power for the operation of the image forming apparatus 100.

### [2] CONFIGURATION OF TONER CONTAINER

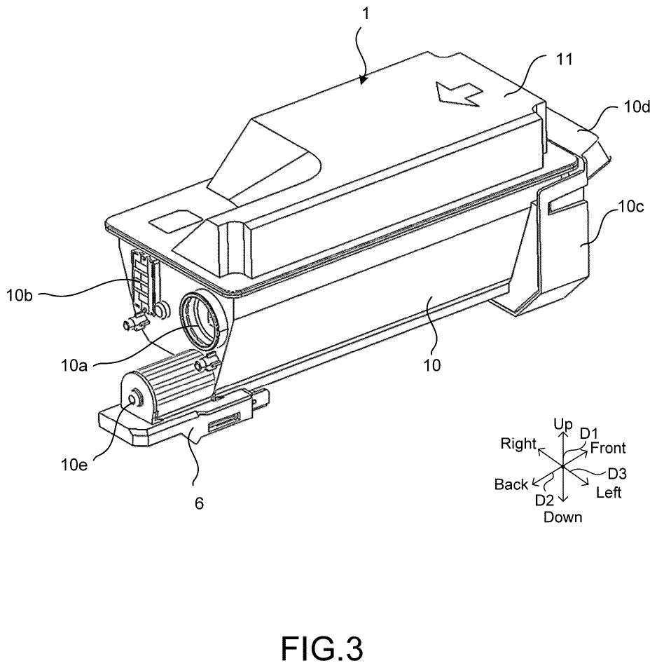

Next, a configuration of the toner container 1 according to the present embodiment will be described in more detail with reference to FIGS. 3 to 10.

As shown in FIG. 3, the toner container 1 includes a container body 10 and a cover member 11. The container body 10 and the cover member 11 are made of a synthetic resin, such as an ABS resin or PET resin. An opening (not shown) is formed in the upper surface of the container body 10. The cover member 11 closes the opening.

As shown in FIG. 3, the container body 10 has a rectangular parallelepiped shape long in the front and back directions D2 and stores toner for use in developing processing by the developing device 104. A filling port 10a for filling the inside of the container body 10 with toner is provided in a rear surface of the container body 10. Moreover, a board 10b on which a circuit that stores identification information specific to the toner container 1 is mounted on the rear surface of the container body 10. The identification information stored in the circuit mounted on the board 10b is scanned by a wireless communication circuit (not shown) including the image forming apparatus 100 in a state in which the toner container 1 is attached to the attachment target part 105. Accordingly, in the image forming apparatus 100, it is determined whether or not the toner container 1 is a genuine product corresponding to the image forming apparatus 100.

Moreover, a cover member 10c with a handle 10d is mounted on a front surface of the container body 10. Accordingly, the user can attach the toner container 1 to the attachment target part 105 by grabbing the handle 10d and inserting the toner container 1 toward the attachment target part 105. Moreover, the user is capable of detaching the toner container 1 from the attachment target part 105 by grabbing the handle 10d and pulling the toner container 1 from the attachment target part 105.

As shown in FIG. 4, the delivery port 12 is formed in a bottom portion at a rear end of the container body 10. The delivery port 12 delivers toner to the outside from the inside of the container body 10 by making the inside of the container body 10 communicate with the outside. In the present embodiment, the delivery port 12 is arranged on the left side in the bottom portion at the rear end of the container body 10. The delivery port 12 is an opening for supplying the toner stored in the container body 10 to the developing device 104 when the toner container 1 is attached to the attachment target part 105.

In the present embodiment, when the toner container 1 is attached to the attachment target part 105, the delivery port 12 is aligned with the replenishment port 104a (see FIG. 2) provided in the developing device 104. Here, the phrase “aligned with” means that the delivery port 12 and the replenishment port 104a are aligned in the up and down directions D1 so that the delivery port 12 and the replenishment port 104a are positioned to be capable of delivering the toner to the replenishment port 104a from the delivery port 12. In this state, when the spiral axis 13 rotates by driving force transmitted to a spiral axis 13 as a convey member provided inside the toner container 1, the toner in the container body 10 is pushed out by the spiral axis 13 and the toner is conveyed to the delivery port 12. Accordingly, the toner in the container body 10 is supplied to the developing device 104 from the delivery port 12 through the replenishment port 104a.

By the way, as a related technology, a toner cartridge with a shutter is known. The toner cartridge includes a toner cartridge body that stores toner and a discharge port for supplying the toner stored in the toner cartridge body to the image forming apparatus. The toner cartridge further includes a single shutter. The shutter opens the discharge port when the toner cartridge body is attached to the image forming apparatus. The shutter closes the discharge port when the toner cartridge body is detached from the image forming apparatus.

By the way, in such a related technology, for example, when the toner cartridge (toner container) is detached from the image forming apparatus, the single shutter closes the discharge port (delivery port), thereby suppressing toner leakage from the discharge port. However, in that related technology, when the single shutter closes the discharge port, the single shutter slides in proximity to the discharge port, thereby scraping off toner delivered from the discharge port. Therefore, there is a problem that the scraped off toner may stick to the outer surface of the toner cartridge body (container body) and the sticking toner may contaminate the outside of the toner cartridge body.

In this regard, in the present embodiment, the toner container 1 and the image forming apparatus 100 can be realized, in which the toner container 1 to be described below makes it easier to suppress contamination of the outside of the container body 10 by the toner sticking to the outer surface of the container body 10.

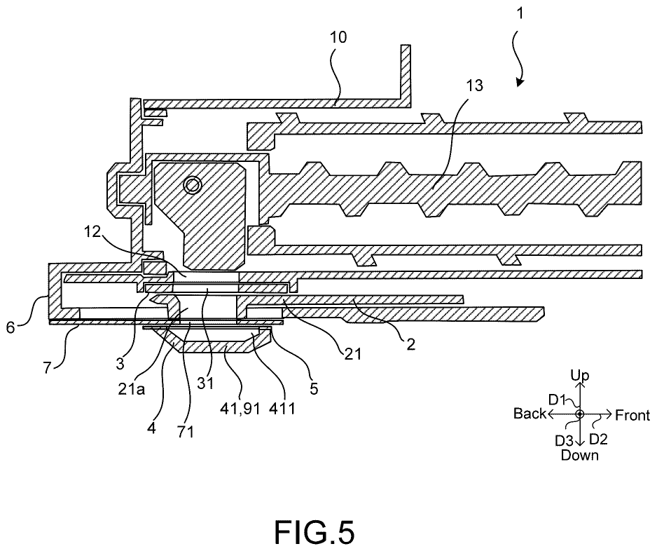

Specifically, a first shutter 2, a first seal member 3, a second shutter 4, a sheet member 5, a retaining member 6, and a second seal member 7 are mounted on the bottom portion at the rear end of the container body 10 as shown in FIGS. 4 and 5. In FIG. 4, the view surrounded by the broken line shows a perspective view of the second shutter 4. Moreover, in the schematic cross-sectional view shown in FIG. 5, only main parts of the toner container 1 are shown and the illustration of those other than the main parts is omitted. Specifically, the first shutter 2 and the second shutter 4 are both retained by the retaining member 6. Then, the retaining member 6 is mounted on the bottom portion at the rear end of the container body 10 in the form of covering the delivery port 12.

As shown in FIGS. 4 and 5, the first shutter 2 is configured to be movable between a first close position to close the delivery port 12 in the container body 10 and a first open position to open the delivery port 12. The first shutter 2 is retained by the retaining member 6 and is configured to be slidable along removal and insertion directions (here, the front and back directions D2) of the toner container 1 with respect to the attachment target part 105. The first shutter 2 is, for example, made of a synthetic resin and includes a main portion 21 and a mounting part 22.

The main portion 21 is a plate-shaped member long in the front and back directions D2. An opening 21a, which extends in a thickness direction (here, the up and down directions D1), is provided in a rear end portion of the main portion 21. The opening 21a has a rectangular shape in a planar view and has substantially the same size as the delivery port 12. In a state in which the toner container 1 is detached from the attachment target part 105, the opening 21a is located at a position not overlapping the delivery port 12 in the up and down directions D1. At that position, a site of the main portion 21 excluding the opening 21a closes the delivery port 12. Therefore, that position corresponds to the first close position. On the other hand, in a state in which the toner container 1 is attached to the attachment target part 105, a position of the main portion 21 relative to the container body 10 is displaced by a shutter open/close mechanism 91 to be described later. As a result, the opening 21a is located at a position aligned with the delivery port 12 in the up and down directions D1. That position corresponds to the first open position.

The mounting part 22 is formed to protrude forward from a front end of the main portion 21 and includes a pair of first mounting pieces 221, a pair of second mounting pieces 222, and a pair of projections 223.

The pair of first mounting pieces 221 each has a rectangular shape long in the front and back directions D2 and projects rearward from both ends of the main portion 21 in the width direction (here, the left and right directions D3). Moreover, the pair of first mounting pieces 221 also projects upward from an upper surface of the main portion 21.

The pair of second mounting pieces 222 is respectively formed to project downward from front ends of the pair of first mounting pieces 221 and further protrude rearward from lower ends of the projecting sites. Therefore, groove parts 224 long in the front and back directions D2 are respectively formed between the first mounting pieces 221 and the second mounting pieces 222. By inserting and fitting a main portion 61 (to be described later) of the retaining member 6 into the groove parts 224, the first shutter 2 is retained by the retaining member 6 to be slidable in the front and back directions D2.

The pair of projections 223 projects downward from the rear ends of the pair of second mounting pieces 222, respectively. The pair of projections 223 is respectively engaged with parts of the lock member 8 (to be described later) provided in the housing 101 of the image forming apparatus 100 during the process of inserting the toner container 1 into the attachment target part 105. Accordingly, the first shutter 2 including the pair of projections 223 is fixed.

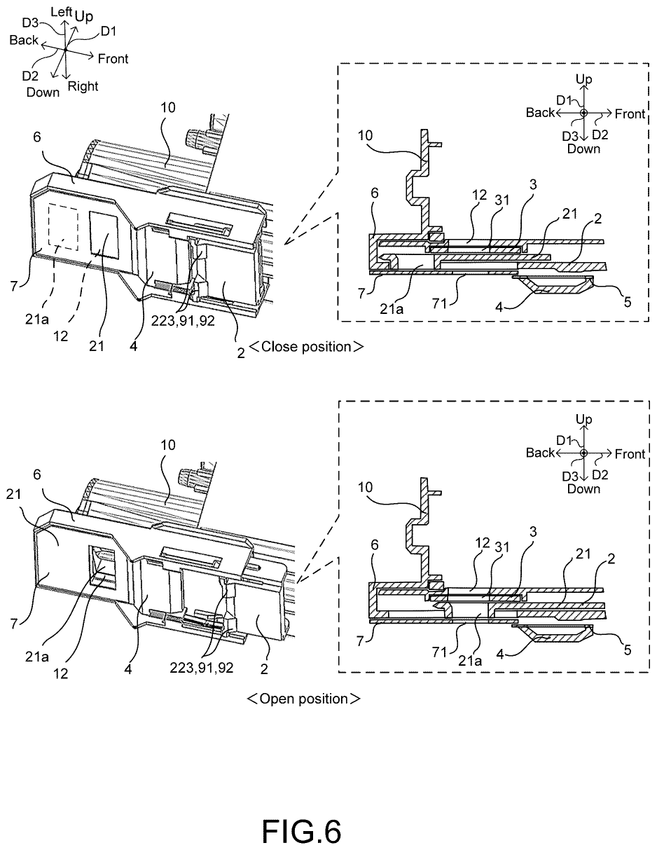

Hereinafter, an operation of the first shutter 2 will be described with reference to FIG. 6. In FIG. 6, the view surrounded by the broken line shows a cross-sectional view showing main parts of the container body 10, the first shutter 2, the second shutter 4, the retaining member 6, and the first seal member 3. It should be noted that in the cross-sectional view, only the main parts related to the operation of the first shutter 2 are shown and the illustration of those other than the main parts is omitted. Moreover, in FIG. 6, the second shutter 4 is held at the second open position.

As mentioned above, the first shutter 2 is fixed in such a manner that the pair of projections 223 of the first shutter 2 is engaged with the part of the lock member 8 during the process of inserting the toner container 1 into the attachment target part 105. When the toner container 1 is further inserted to be attached to the attachment target part 105, the container body 10 and the retaining member 6 are moved rearward while the first shutter 2 is still fixed. Accordingly, as shown in <open position> in FIG. 6, the opening 21a is located at a position (i.e., the first open position) aligned with the delivery port 12 in the up and down directions D1.

Here, the fixed state of the first shutter 2 including the pair of projections 223 is maintained while the pair of projections 223 is engaged with the parts of the lock member 8. When the toner container 1 is pulled out of the attachment target part 105 in this state, the container body 10 and the retaining member 6 are moved forward while the first shutter 2 is still fixed. Accordingly, as shown in <close position> in FIG. 6, the opening 21a is located at the position (i.e., the first close position) not overlapping the delivery port 12 in the up and down directions D1.

That is, the pair of projections 223 functions as the shutter open/close mechanism 91. Here, the shutter open/close mechanism 91 is a mechanism that moves the first shutter 2 from the first close position to the first open position when the toner container 1 is attached to the attachment target part 105. Moreover, the shutter open/close mechanism 91 is a mechanism that moves the first shutter 2 from the first open position to the first close position when the toner container 1 is detached from the attachment target part 105. It should be noted that details of the operation of opening/closing the first shutter 2 by the shutter open/close mechanism 91 will be described later.

Moreover, the pair of projections 223 each has a function of fixing the first shutter 2 at the first open position in a state in which the toner container 1 is attached to the attachment target part 105 in such a manner that the pair of projections 223 is engaged with the parts of the lock member 8 provided in the image forming apparatus 100. Accordingly, even if external force is added to the toner container 1 due to vibrations or the like in a state in which the toner container 1 is attached to the attachment target part 105, the first shutter 2 is easily held at the first open position. Therefore, there is an advantage that the toner is stably supplied to the developing device 104 from the container body 10. Moreover, the pair of projections 223 each has a function of canceling the fixation of the first shutter 2 in such a manner that the engagement with the part of the lock member 8 is canceled. That is, the pair of projections 223 functions as a lock mechanism 92. Here, the lock mechanism 92 is a mechanism of fixing the first shutter 2 at the first open position when the toner container 1 is attached to the attachment target part 105 and canceling the fixation of the first shutter 2 when the toner container 1 is moved in a direction to be detached from the attachment target part 105. It should be noted that details of the operation of the lock mechanism 92 will be described later.

As shown in FIG. 4, the first seal member 3 is arranged between the first shutter 2 and the delivery port 12 and is configured to seal a gap between the first shutter 2 and a peripheral edge of the delivery port 12. Here, when the first shutter 2 is displaced from the first open position to the first close position, the first shutter 2 slides in the front and back directions D2, thereby scraping off the toner delivered from the delivery port 12. At this time, without the first seal member 3, there is a relatively large space between the first shutter 2 and the peripheral edge of the delivery port 12. Therefore, the amount of toner scraped off by the first shutter 2 may increase and the amount of toner sticking to the outer surface of the container body 10 may increase. In view of this, such space can be reduced with the first seal member 3 between the first shutter 2 and the peripheral edge of the delivery port 12. There is an advantage that this reduces the amount of toner scraped off by the first shutter 2, which easily reduces the amount of toner sticking to the outer surface of the container body 10.

The first seal member 3 is a plate-shaped member whose dimension in the thickness direction (here, the up and down directions D1) is substantially the same as a thickness dimension of the main portion 21 of the first shutter 2. The first seal member 3 is made of an elastic material, such as a silicon rubber, urethane, or sponge. The first seal member 3 is mounted on the container body 10 by being bonded to the peripheral edge of the delivery port 12 in a bottom portion of the container body 10 with an adhesive, for example. Moreover, a rectangular opening 31 is provided in the first seal member 3 in a planar view, which extends in the thickness direction. The opening 31 is provided at a position facing the delivery port 12. Therefore, the toner in the container body 10 is delivered to the outside via the delivery port 12 and the opening 31.

As shown in FIGS. 4 and 5, the second shutter 4 is arranged at a position farther from the delivery port 12 than the first shutter 2 in the delivery direction (here, the up and down directions D1) in which the toner is delivered from the delivery port 12. Then, the second shutter 4 is configured to be movable between the second close position to close the delivery port 12 in the container body 10 and the second open position to open the delivery port 12. The second shutter 4 is retained by the retaining member 6 and is configured to be slidable along the removal and insertion directions (here, the front and back directions D2) of the toner container 1 with respect to the attachment target part 105. The second shutter 4 is, for example, made of a synthetic resin and includes a main portion 41, a pair of mounting pieces 42, and a pair of bias members 43.

The main portion 41 is a plate-shaped member long in the front and back directions D2 and having a thickness larger than the main portion 21 of the first shutter 2. The main portion 41 includes a recess portion 411 recessed in a direction (i.e., lower direction) away from the delivery port 12 in the thickness direction (here, the up and down directions D1). An outer wall of the recess portion 411 is brought into contact with a part of the developing device 104 (here, the seal member 104b) during the process of inserting the toner container 1 into the attachment target part 105.

In a state in which the toner container 1 is detached from the attachment target part 105, the main portion 41 is located at the position not overlapping the delivery port 12 in the up and down directions D1. That position corresponds to the second open position. On the other hand, in a state in which the toner container 1 is attached to the attachment target part 105, the main portion 41 is located at a position aligned with the delivery port 12 in the up and down directions D1 by a position of the main portion 41 relative to the container body 10 being displaced by the shutter open/close mechanism 91. That position corresponds to the second close position.

The pair of mounting pieces 42 is made up of members that project forward from right and left side surfaces of the main portion 41, respectively, and each have a flat plate shape long in the front and back directions D2. A pair of protrusion pieces 421 that protrudes in outward directions in the width direction (here, the left and right directions D3), respectively, is integrally formed at front ends of the pair of mounting pieces 42.

The pair of mounting pieces 42 is fitted in a pair of retaining pieces 62c (to be described later) of the retaining member 6, respectively. Accordingly, the second shutter 4 is retained by the retaining member 6 to be slidable in the front and back directions D2. Moreover, the pair of protrusion pieces 421 is respectively inserted into a pair of slits 62a (to be described later) of the retaining member 6 in a state in which the retaining member 6 retains the second shutter 4, thereby limiting a range in which the second shutter 4 is slidable in the front and back directions D2.

The pair of bias members 43 is coil springs long in the front and back directions D2 and is mounted on the pair of mounting pieces 42, respectively, by inserting the pair of mounting pieces 42 into their hollow portions. Front end portions of the pair of bias members 43 are respectively engaged with the pair of retaining pieces 62c of the retaining member 6 in a state in which the retaining member 6 retains the second shutter 4. Accordingly, when the main portion 41 is displaced forward relative to the retaining member 6, each of the pair of bias members 43 stores elastic energy by contracting and biases the main portion 41 in a direction to move the main portion 41 rearward.

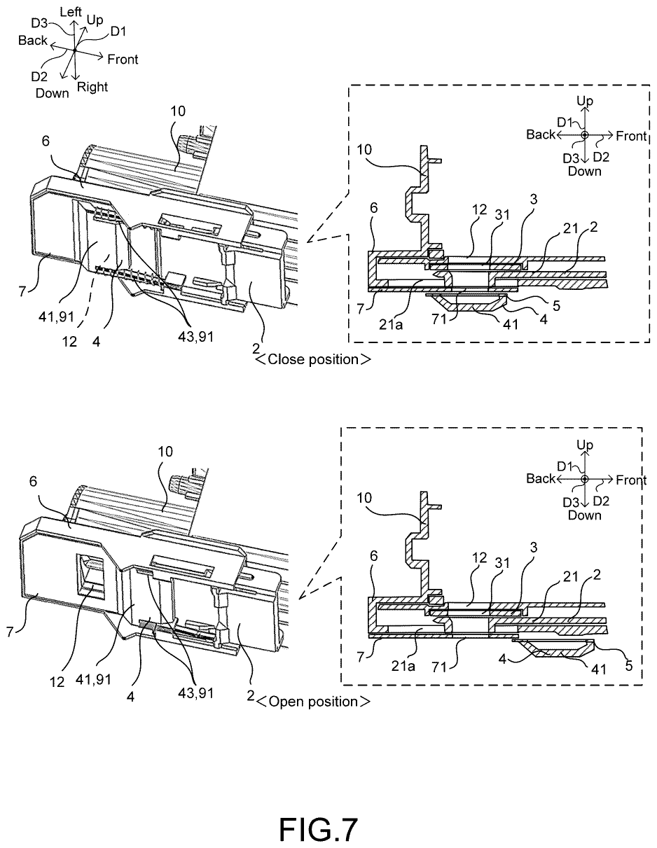

Hereinafter, an operation of the second shutter 4 will be described with reference to FIG. 7. In FIG. 7, the view surrounded by the broken line shows a cross-sectional view showing main parts of the container body 10, the first shutter 2, the second shutter 4, the retaining member 6, and the first seal member 3. It should be noted that in the cross-sectional view, only main parts related to the operation of the second shutter 4 are shown, and the illustration of those other than the main parts is omitted. Moreover, in FIG. 7, the first shutter 2 is held at the first open position.

During the process of inserting the toner container 1 into the attachment target part 105, the main portion 41 is engaged with the part of the developing device 104 including the image forming apparatus 100. Accordingly, the second shutter 4 including the main portion 41 is fixed. When the toner container 1 is further inserted to be attached to the attachment target part 105, the container body 10 and the retaining member 6 are moved rearward while the second shutter 4 is still fixed. Accordingly, as shown in <open position> in FIG. 7, the main portion 41 is located at the position (i.e., the second open position) not overlapping the delivery port 12 in the up and down directions D1. At this time, since the main portion 41 is displaced forward relative to the retaining member 6, the pair of bias members 43 stores elastic energy by contracting.

Here, the fixed state of the second shutter 4 including the main portion 41 is maintained until the toner container 1 is detached from the attachment target part 105. When the toner container 1 is pulled out of the attachment target part 105 in this state, the container body 10 and the retaining member 6 are moved forward. As a result, the fixation of the main portion 41 is canceled. Then, the pair of bias members 43 attempts to release the stored elastic energy and return to the original state, so the main portion 41 is displaced rearward relative to the retaining member 6. Accordingly, as shown in <close position> in FIG. 7, the main portion 41 is located at a position (i.e., the second close position) that is aligned with the delivery port 12 in the up and down directions D1.

That is, the main portion 41 and the pair of bias members 43 function as the shutter open/close mechanism 91. Here, the shutter open/close mechanism 91 is a mechanism that moves the second shutter 4 from the second close position to the second open position when the toner container 1 is attached to the attachment target part 105. Moreover, the shutter open/close mechanism 91 is a mechanism that moves the second shutter 4 from the second open position to the second close position when the toner container 1 is detached from the attachment target part 105. It should be noted that details of the operation of opening/closing the second shutter 4 by the shutter open/close mechanism 91 will be described later.

The sheet member 5 is a thin film-shaped member. The sheet member 5 is made of an elastic material, such as a silicon rubber, urethane, or sponge. As shown in FIG. 4, the sheet member 5 is arranged at a peripheral edge of the recess portion 411 of the main portion 41 of the second shutter 4 and is configured to wipe off toner. Specifically, the sheet member 5 is provided at a position proximate to a lower surface of the second seal member 7 to be capable of wiping off toner leaking out of an opening 71 (to be described later) of the second seal member 7. Accordingly, the second seal member 7 slides in the front and back directions D2 while approaching the sheet member 5 along with open/close of the second shutter 4. As a result, the sheet member 5 can wipe off toner leaking out of the opening 71 of the second seal member 7. Therefore, there is an advantage that the provision of the sheet member 5 makes it much easier to reduce the amount of toner sticking to the outer surface of the container body 10.

The sheet member 5 is a frame-shaped member rectangular in a planar view whose dimension in the thickness direction (here, the up and down directions D1) is smaller than the thickness dimension of the main portion 41 of the second shutter 4. The sheet member 5 is made of an elastic material, such as a silicon rubber, urethane, or sponge. The sheet member 5 is mounted on the second shutter 4 by being bonded to the peripheral edge of the recess portion 411 at an upper surface of the main portion 41 with an adhesive, for example.

As shown in FIG. 4, the retaining member 6 is a member that is mounted on the container body 10 and retains the first shutter 2 and the second shutter 4 in a movable state. Specifically, the retaining member 6 is mounted on the container body 10 to cover the delivery port 12 in the bottom portion at the rear end of the container body 10. Moreover, the retaining member 6 retains the first shutter 2 on an upper side in the thickness direction (here, the up and down directions D1) while sandwiching an insertion piece 63 to be described later and retains the second shutter 4 on a lower side in the thickness direction. Moreover, the first shutter 2 and the second shutter 4 are retained by the retaining member 6 in an independently slidable state.

Accordingly, the retaining member 6 retaining the first shutter 2 and the second shutter 4 is mounted on the container body 10. As a result, the first shutter 2 and the second shutter 4 can be indirectly mounted on the container body 10. Therefore, there is an advantage that the first shutter 2 and the second shutter 4 are easily mounted on the container body 10 as compared to a case where the first shutter 2 and the second shutter 4 are individually directly mounted on the container body 10.

The retaining member 6 includes a main portion 61, a pair of side walls 62, the insertion piece 63, and a coupling piece 64.

The main portion 61 is a box-shaped member long in the front and back directions D2 and is hollow inside. The main portion 21 of the first shutter 2 is housed in the hollow portion of the main portion 61 in a state in which the retaining member 6 retains the first shutter 2. An upper opening 61a rectangular in a planar view, which extends in the thickness direction (here, the up and down directions D1), is provided in an upper surface of the main portion 61. Moreover, a lower opening 61b rectangular in a planar view, which extends in the thickness direction, is provided in a lower surface of the main portion 61. The lower opening 61b has an opening area larger than an opening area of the upper opening 61a.

The pair of side walls 62 is provided at both ends of the main portion 61 in the width direction (here, the left and right directions D3), respectively. In each of the pair of side walls 62, the upper end projects more upward than the upper surface of the main portion 61 and the lower end projects more downward than the lower surface of the main portion 61.

A pair of slits 62a rectangular in a planar view, which is long in the front and back directions D2, is provided in lower end portions of the pair of side walls 62, respectively. The pair of slits 62a is respectively inserted in the pair of protrusion pieces 421 in a state in which the retaining member 6 retains the second shutter 4.

A pair of restraining pieces 62b that protrudes in an inward direction in the width direction (here, the left and right directions D3) is integrally formed at upper ends of the pair of side walls 62, respectively. The pair of restraining pieces 62b restricts the upward movement of the first shutter 2 by sandwiching the first shutter 2 between the insertion piece 63 and the pair of restraining pieces 62b in a state in which the retaining member 6 retains the first shutter 2.

Moreover, the pair of retaining pieces 62c that protrudes in the inward direction in the width direction (here, the left and right directions D3) is integrally formed at the lower ends of the pair of side walls 62, respectively. The pair of retaining pieces 62c retains the second shutter 4 including the pair of mounting pieces 42 by sandwiching the pair of mounting pieces 42 between the lower surface of the insertion piece 63 and the pair of retaining pieces 62c, respectively.

The insertion piece 63 is a plate-shaped member that projects forward from a rear end of the main portion 61 and has a length in the front and back directions D2. The insertion piece 63 is fitted in a pair of groove parts 224 in a state in which the retaining member 6 retains the first shutter 2.

The coupling piece 64 is a plate-shaped member that projects upward from the upper surface at the rear end of the main portion 61. A coupling part 64a having a circular shape in a planar view is formed in the front surface of the coupling piece 64 and is configured to be capable of being coupled with a coupling target part 10e (see FIG. 4) provided at the rear end of the container body 10. Then, the retaining member 6 retaining the first shutter 2 and the second shutter 4 can be mounted on the container body 10 by coupling the coupling part 64a to the coupling target part 10e. Accordingly, the first shutter 2 and the second shutter 4 can be indirectly mounted on the container body 10 via the retaining member 6.

The second seal member 7 is configured to seal a gap between the first shutter 2 and the second shutter 4. The second seal member 7 is a thin film-shaped member. The second seal member 7 is made of an elastic material, such as a silicon rubber, urethane, or sponge. As shown in FIG. 4, the second seal member 7 is bonded to a peripheral edge of the lower opening 61b with an adhesive, for example, to cover the lower opening 61b of the main portion 61 of the retaining member 6. Moreover, the opening 71 rectangular in a planar view, which extends in the thickness direction (here, the up and down directions D1), is provided in the second seal member 7. The opening 71 is provided at a position facing the delivery port 12 in a state in which the retaining member 6 is mounted on the container body 10. Therefore, the toner in the container body 10 is delivered outside via the delivery port 12 and the opening 71.

Hereinafter, the retaining member 6 retaining the first shutter 2 and a method of mounting the second shutter 4 on the container body 10 will be described with reference to FIG. 4. First of all, the first seal member 3 is bonded to the bottom portion at the rear end of the container body 10. Next, the second seal member 7 is bonded to the peripheral edge of the lower opening 61b in the main portion 61 of the retaining member 6 to cover the lower opening 61b. Next, the first shutter 2 is mounted on the upper side of the main portion 61 of the retaining member 6 and the second shutter 4 is mounted between the lower surface of the main portion 61 of the retaining member 6 and the second seal member 7. It should be noted that the order in which the first shutter 2 and the second shutter 4 are mounted may be opposite. Finally, the retaining member 6 retaining the first shutter 2 and the second shutter 4 is mounted on the container body 10 by coupling the coupling part 64a to the coupling target part 10e of the container body 10.

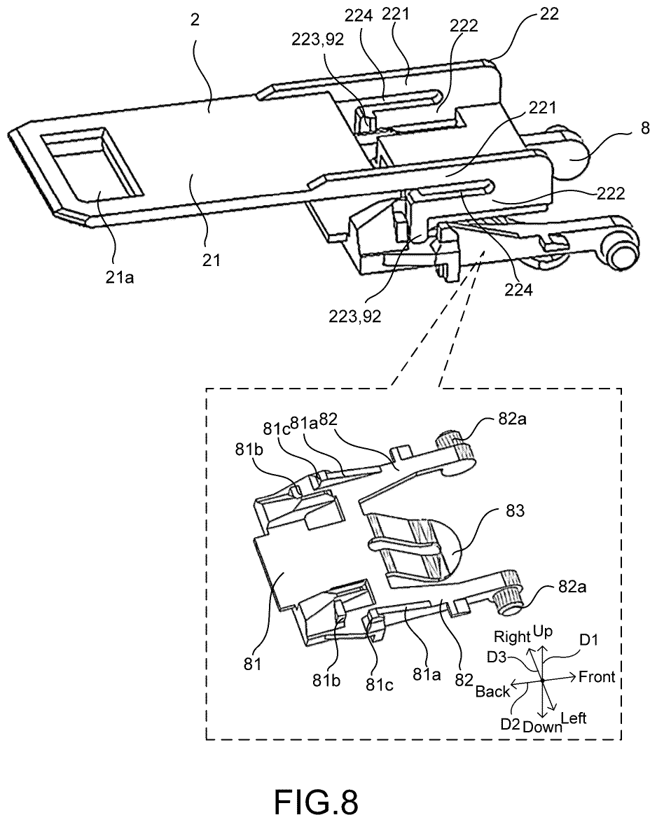

The lock member 8 is arranged in the housing 101 of the image forming apparatus 100. Specifically, the lock member 8 forms a part of the attachment target part 105 in the housing 101 and is arranged with a spacing from the replenishment port 104a of the developing device 104 in front of the developing device 104. As shown in FIG. 8, the lock member 8 includes a main piece 81, a pair of projection pieces 82, and an elastic piece 83. It should be noted that In FIG. 8, the view surrounded by the broken line shows a schematic perspective view of the lock member 8.

The main piece 81 is a plate-shaped member in a planar view, which is long in the front and back directions D2. Tapers 81a and projecting walls 81b are integrally formed at the both ends of the main piece 81 in the width direction (here, the left and right directions D3), respectively. The tapers 81a project from the upper surface of the main piece 81 and are inclined upward toward the rear end from the front end of the main piece 81. The projecting walls 81b project upward from the upper surface of the main piece 81 and are arranged with a spacing from downward surfaces 81c at the rear ends of the tapers 81a in the front and back directions D2. The spacing is substantially equivalent to the dimension of each projection 223 of the first shutter 2 in the front and back directions D2.

The pair of projection pieces 82 is made up of members that project forward from the both ends in the width direction (here, the left and right directions D3) at a rear end of the main piece 81, respectively, and has flat plate shapes long in the front and back directions D2. A pair of shaft portions 82a mounted in the form rotatable in the housing 101 of the image forming apparatus 100 is provided at rear ends of the pair of projection pieces 82, respectively. Therefore, the main piece 81 is capable of swinging in a clockwise or counter-clockwise direction as viewed in the left and right directions D3, using the pair of shaft portions 82a as an axis.

The elastic piece 83 is a flat plate-shaped member that projects forward and downward from a center portion at the rear end of the main piece 81 in the width direction (here, the left and right directions D3). When the elastic piece 83 is displaced downward in such a manner that the main piece 81 is pushed by the pair of projections 223 of the first shutter 2, the elastic piece 83 stores energy by bending downward together with the main piece 81 and biases the main piece 81 in a direction to move the main piece 81 upward.

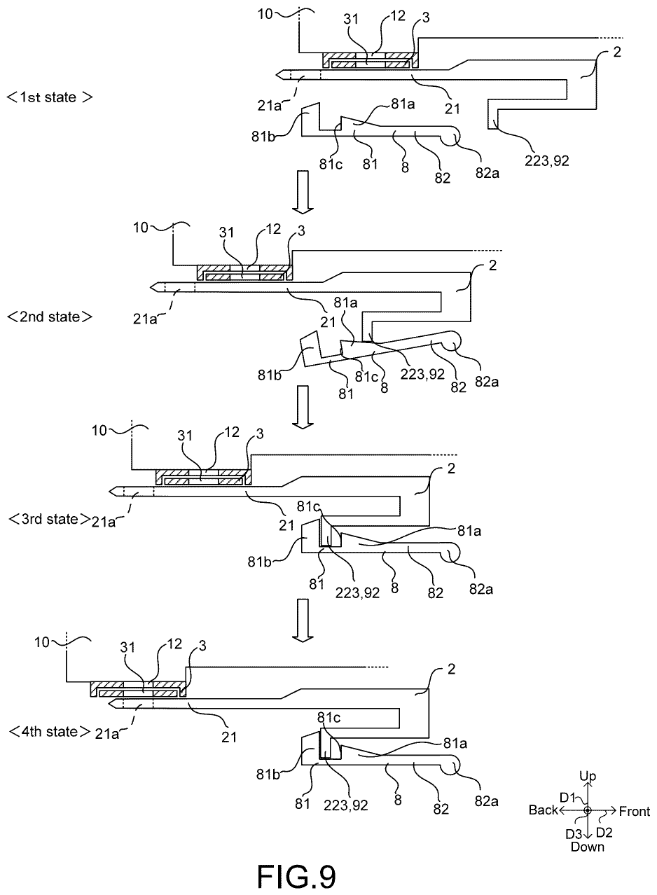

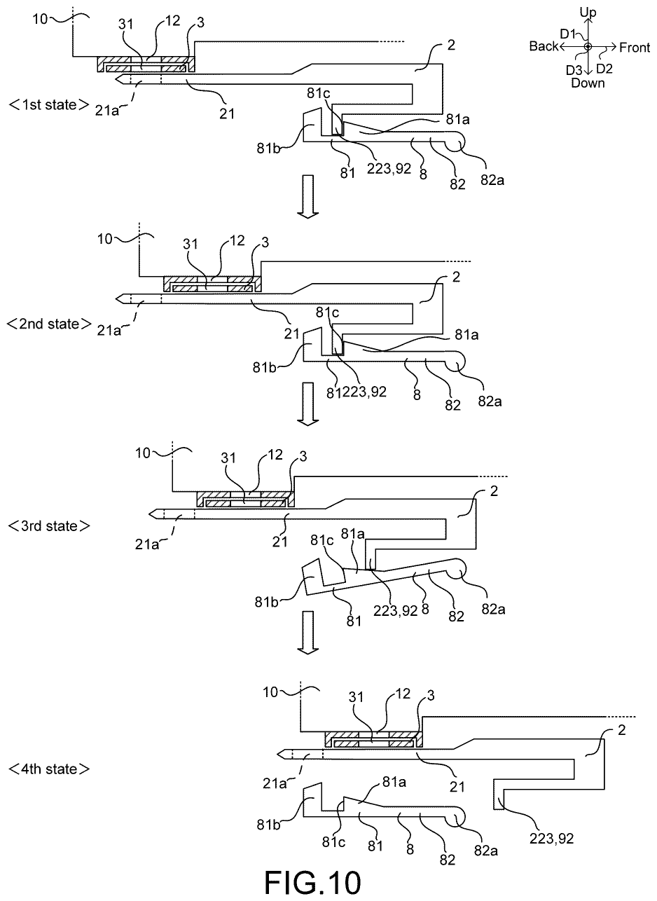

Hereinafter, an operation of the lock mechanism 92 (in the present embodiment, the pair of projections 223 of the first shutter 2) will be described with reference to FIGS. 9 and 10. FIG. 9 shows an operation of fixing the first shutter 2 at the first open position by the lock mechanism 92. FIG. 10 shows an operation to cancel the fixation of the first shutter 2 by the lock mechanism 92. It should be noted that in each of FIGS. 9 and 10, only a schematic view of the container body 10, the first shutter 2, and the lock member 8 is shown and the illustration of details of the portion of each of the container body 10, the first shutter 2, and the lock member 8 is omitted.

First of all, an operation of fixing the first shutter 2 at the first open position by the lock mechanism 92 will be described with reference to FIG. 9. As shown in <first state> in FIG. 9, the user inserts the toner container 1 rearward with respect to the attachment target part 105 in order to attach the toner container 1 to the attachment target part 105. In this state, the first shutter 2 is at the first close position.

When the toner container 1 goes inside the attachment target part 105, the pair of projections 223 of the first shutter 2 respectively comes into contact with the pair of tapers 81a of the lock member 8 and move rearward while pushing the pair of tapers 81a downward as shown in <second state> in FIG. 9. In this state, the elastic piece 83 is displaced downward together with the main piece 81 and bends, thereby storing elastic energy.

When the toner container 1 further goes inside the attachment target part 105, the pair of projections 223 of the first shutter 2 respectively goes beyond the pair of tapers 81a of the lock member 8 and comes into contact with the pair of projecting walls 81b as shown in <third state>in FIG. 9. The force of pushing the pair of tapers 81a by the pair of projections 223 downward is lost in this state. As a result, the elastic piece 83 releases the stored elastic energy and returns to the original state. Accordingly, the movable range of each of the pair of projections 223 is restricted to be within the range between the projecting walls 81b and the downward surfaces 81c of the tapers 81a. That is, the first shutter 2 is fixed in such a manner that the pair of projections 223 is engaged with the parts of the lock member 8.

When the toner container 1 is attached to the attachment target part 105, the first shutter 2 is fixed by the lock member 8 while the container body 10 is moved rearward as shown in <fourth state> in FIG. 9. Accordingly, since the container body 10 is displaced rearward relative to the first shutter 2 (i.e., the first shutter 2 is displaced forward relative to the container body 10), the opening 21a of the first shutter 2 is a position aligned with the delivery port 12 in the up and down directions D1. That is, the first shutter 2 is located at the first open position.

Next, an operation of canceling the fixation of the first shutter 2 by the lock mechanism 92 will be described with reference to FIG. 10. The user pulls the toner container 1 forward with respect to the attachment target part 105 as shown in <first state> in FIG. 10 in order to detach the toner container 1 from the attachment target part 105. Then, the pair of projections 223 of the first shutter 2 respectively moves forward and comes into contact with the downward surfaces 81c of the pair of tapers 81a.

When the toner container 1 is further pulled forward with respect to the attachment target part 105, the first shutter 2 is fixed by the lock member 8 while the container body 10 is moved forward as shown in <second state> in FIG. 10. Accordingly, since the container body 10 is displaced forward relative to the first shutter 2 (i.e., the first shutter 2 is displaced rearward relative to the container body 10), the opening 21a of the first shutter 2 is located at the position not overlapping the delivery port 12. That is, the first shutter 2 is located at the first close position.

When the toner container 1 is further pulled with respect to the attachment target part 105, the pair of projections 223 respectively goes beyond the downward surfaces 81c of the pair of tapers 81a as shown in <third state> in FIG. 10. Accordingly, the fixation of the first shutter 2 is canceled by canceling the engagement of the pair of projections 223 with the parts of the lock member 8. Then, the pair of projections 223 moves rearward while pushing the pair of tapers 81a downward. In this state, the elastic piece 83 stores elastic energy by being displaced downward together with the main piece 81 and bending.

When the toner container 1 is detached from the attachment target part 105, as shown in <fourth state> in FIG. 10, the force of pushing the pair of tapers 81a by the pair of projections 223 downward is lost. As a result, the elastic piece 83 releases the stored elastic energy and returns to the original state.

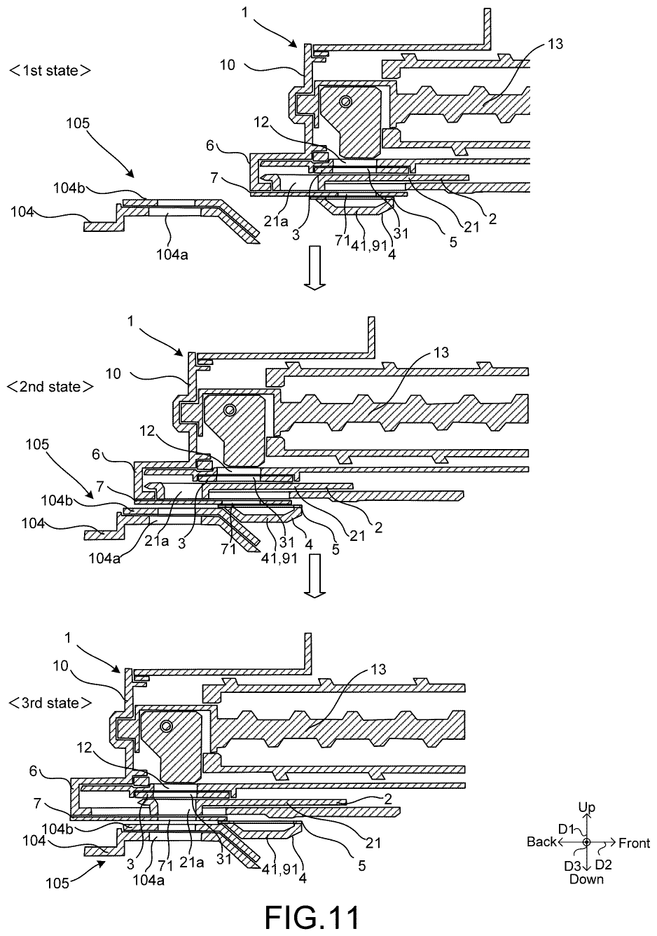

Hereinafter, a motion of the first shutter 2 and the second shutter 4 when the toner container 1 is attached to the attachment target part 105 will be described with reference to FIG. 11. It should be noted that in FIG. 11, only main parts related to the operation of the first shutter 2 and the second shutter 4 are shown and the illustration of those other than the main parts is omitted.

As shown in <first state> in FIG. 11, the user inserts the toner container 1 inserts with respect to the attachment target part 105 in order to attach the toner container 1 to the attachment target part 105. In this state, the first shutter 2 is at the first close position and the second shutter 4 is at the second close position.

When the toner container 1 is further inserted into the attachment target part 105, as shown in <second state> in FIG. 11, the main portion 41 of the second shutter 4 is brought into contact with the part of the developing device 104 (here, the seal member 104b). Then, the main portion 41 is engaged with the seal member 104b. As a result, the rearward movement of the second shutter 4 is restricted and the second shutter 4 is fixed. Therefore, as the toner container 1 is thereafter inserted, the container body 10 and the retaining member 6 are moved rearward while the second shutter 4 is still fixed. Accordingly, the main portion 41 of the second shutter 4 is displaced to the position (i.e., the second open position) not overlapping the delivery port 12 in the up and down directions D1. Since the main portion 41 is displaced forward relative to the retaining member 6 at this time, the pair of bias members 43 stores elastic energy by contracting.

Then, during the process of further inserting the toner container 1, the pair of projections 223 of the first shutter 2 is engaged with the part of the lock member 8. As a result, the rearward movement of the first shutter 2 is restricted and the first shutter 2 is fixed. When the toner container 1 is further inserted to be attached to the attachment target part 105, the container body 10 and the retaining member 6 are moved rearward while the first shutter 2 is fixed. Accordingly, as shown in <third state> in FIG. 11, the first shutter 2 is displaced to a position (i.e., the first open position) where the opening 21a is aligned with the delivery port 12 in the up and down directions D1.

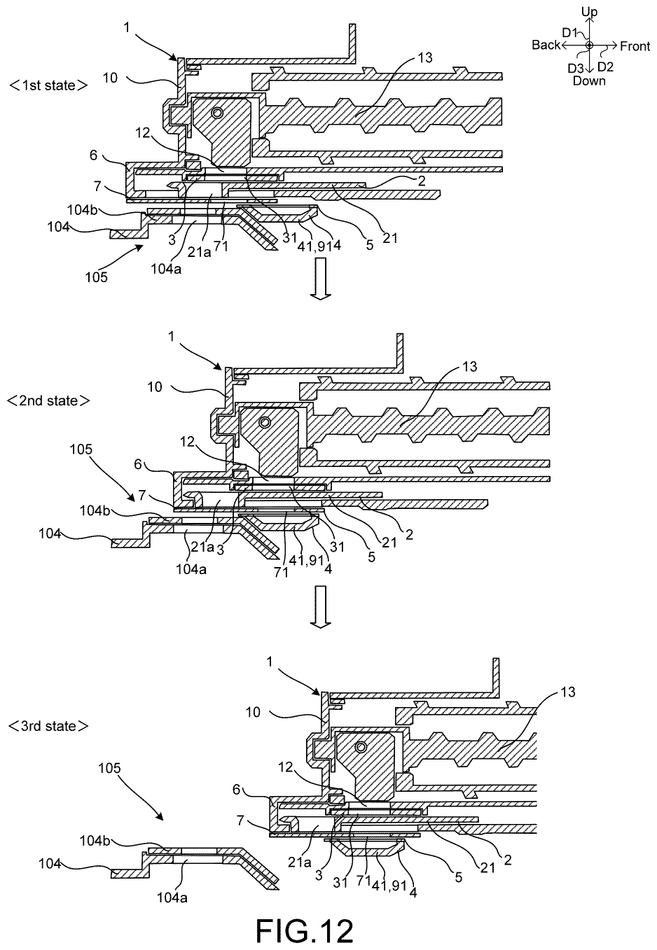

Next, a motion of the first shutter 2 and the second shutter 4 when the toner container 1 is detached from the attachment target part 105 will be described with reference to FIG. 12. It should be noted that in FIG. 12, only main parts related to the operation of the first shutter 2 and the second shutter 4 are shown and the illustration of those other than the main parts is omitted.

The user pulls the toner container 1 forward with respect to the attachment target part 105 in order to detach the toner container 1 from the attachment target part 105. Here, the fixed state of the first shutter 2 is maintained while the pair of projections 223 are engaged with the part of the lock member 8. Therefore, while the first shutter 2 is fixed the container body 10 and the retaining member 6 are moved forward. Accordingly, as shown in <first state> in FIG. 12, the first shutter 2 begins to be displaced to a position (i.e., the first close position) where the opening 21a does not overlap with the delivery port 12 in the up and down directions D1. At this time, the first shutter 2 slides in the front and back directions D2 while the upper surface is approaching the delivery port 12. As a result, the toner delivered from the delivery port 12 is scraped off.

Here, in the present embodiment, the spacing between the first shutter 2 and the first seal member 3 in the thickness direction (here, the up and down directions D1) is maintained less than or equal to the thickness of the second seal member 7. Accordingly, there is an advantage that the scraping operation of the first shutter 2 still more easily reduces the amount of toner sticking to the outer surface of the container body 10.

When the toner container 1 is further pulled, the displacement of the first shutter 2 to the first close position is completed. When the engagement of the pair of projections 223 with the parts of the lock member 8 is canceled, the fixation of the first shutter 2 is also canceled. Therefore, as shown in <second state> in FIG. 12, the container body 10 and the retaining member 6, including the first shutter 2, are moved forward.

When the toner container 1 is further pulled, the fixation of the second shutter 4 is canceled by being spaced away from the seal member 104b of the main portion 41 of the second shutter 4. Then, the pair of bias members 43 attempts to release the stored elastic energy and return to the original state in the phase where the toner container 1 is detached from the attachment target part 105, so the main portion 41 is displaced rearward relative to the retaining member 6. Therefore, as shown in <third state> in FIG. 12, the second shutter 4 is displaced to the position (i.e., the second close position) where the main portion 41 is aligned with the delivery port 12 in the up and down directions D1.

As described above, the toner container 1 according to the present embodiment is configured so that two shutters, the first shutter 2 and the second shutter 4, can open/close the delivery port 12. Therefore, in the toner container 1 according to the present embodiment, when the toner container 1 is attached/detached, the scraping operation of the first shutter 2 enables the second shutter 4 to shield the toner sticking to the outer surface of the container body 10 from the outside of the container body 10. Therefore, the toner container 1 according to the present embodiment has an advantage that the toner sticking to the outer surface of the container body 10 does not easily reach the outside of the container body 10, which easily suppresses the toner's contamination of the outside of the container body 10.

Moreover, in the toner container 1 according to the present embodiment, when the toner container 1 is detached from the attachment target part 105, the pair of projections 223 of the fixation of the first shutter 2 is first canceled as described above. As a result, the first shutter 2 is displaced from the first open position to the first close position. Then, the fixation of the main portion 41 of the second shutter 4 is canceled. As a result, the second shutter 4 is displaced from the second open position to the second close position by the pair of bias members 43. That is, in the present embodiment, when the toner container 1 is detached from the attachment target part 105, the shutter open/close mechanism 91 (the pair of projections 223, the main portion 41, and the pair of bias members 43) moves the second shutter 4 to the second close position after the shutter open/close mechanism 91 moves the first shutter 2 to the first close position. Accordingly, the scraping operation of the first shutter 2 enables the second shutter 4 to shield the toner sticking to the outer surface of the container body 10 from the outside of the container body 10 due to a time difference. Therefore, there is an advantage that contamination of the outside of the container body 10 by the toner sticking to the outer surface of the container body 10 is more easily suppressed as compared to a case where the first shutter 2 and the second shutter 4 are simultaneously moved from the open position to the close position.

### [3] MODIFIED EXAMPLES

In the above-mentioned embodiment, the single second shutter 4 is employed, though not limited thereto. For example, a plurality of second shutters 4 may be employed. In this case, it is sufficient that each of the plurality of second shutters 4 is arranged, aligned with in the thickness direction (here, the up and down directions D1) together with the first shutter 2.

In the above-mentioned embodiment, the image forming apparatus 100 includes the single toner container 1 and the toner stored in the toner container 1 is K (black) toner, though not limited thereto. For example, in a case where the image forming part has a configuration to form full color images using four colors of C (cyan), M (magenta), Y (yellow), and K (black), the image forming apparatus 100 may include four toner containers 1. Moreover, in this case, kinds of toner stored in the four toner containers 1 are toner C (cyan), M (magenta), Y (yellow), and K (black). Moreover, in this case, each toner container 1 can employ a configuration similar to that of the above-mentioned embodiment.

### NOTES OF DISCLOSURE

The outline of the disclosure extracted from the above-mentioned embodiments will be given below. Note that the configurations and processing functions described in the following notes can be arbitrarily selected and combined.

### Note 1

A toner container that is detachably attached to an attachment target part of an image forming apparatus, including:
a container body that stores toner;
a delivery port that delivers the toner to an outside from an inside of the container body;
a first shutter that is movable between a first close position to close the delivery port and a first open position to open the delivery port; and
a second shutter that is arranged at a position farther from the delivery port than the first shutter in a delivery direction in which the toner is delivered from the delivery port and is movable between a second close position to close the delivery port and a second open position to open the delivery port.

### Note 2

The toner container according to Note 1, further including
a retaining member that is mounted on the container body and retains each of the first shutter and the second shutter in a movable state.

### Note 3

The toner container according to Note 1 or 2, further including
a shutter open/close mechanism that moves the first shutter from the first close position to the first open position and moves the second shutter from the second close position to the second open position when the toner container is attached to the attachment target part and that moves the first shutter from the first open position to the first close position and moves the second shutter from the second open position to the second close position when the toner container is detached from the attachment target part.

### Note 4

The toner container according to Note 3, in which
the shutter open/close mechanism moves the second shutter to the second close position after the shutter open/close mechanism moves the first shutter to the first close position when the toner container is detached from the attachment target part.

### Note 5

The toner container according to any one of Notes 1 to 4, further including
a lock mechanism that fixes the first shutter at the first open position when the toner container is attached to the attachment target part and that cancels the fixation of the first shutter when the toner container is moved in a direction to be detached from the attachment target part.

### Note 6

The toner container according to any one of Notes 1 to 5, further including
a first seal member that is arranged between the first shutter and the delivery port and seals a gap between the first shutter and a peripheral edge of the delivery port.

### Note 7

The toner container according to Note 6, further including
a second seal member that seals a gap between the first shutter and the second shutter, in which
a spacing between the first shutter and the first seal member in the thickness direction is less than or equal to a thickness of the second seal member.

### Note 8

The toner container according to any one of Notes 1 to 7, in which
the second shutter has a recess portion recessed in a direction to be spaced away from the delivery port in the thickness direction, the toner container further including
a sheet member that is arranged at a peripheral edge of the recess portion and wipes off the toner.

### Note 9

An image forming apparatus, including:
a toner container according to claim 1;
an attachment target part to which the toner container is attached; and
a housing that houses the attachment target part.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

It should be understood by those skilled in the art that various modifications, combinations, sub-combinations and alterations may occur depending on design requirements and other factors insofar as they are within the scope of the appended claims or the equivalents thereof.

1. A toner container that is detachably attached to an attachment target part of an image forming apparatus, comprising:
a container body that stores toner;
a delivery port that delivers the toner to an outside from an inside of the container body;
a first shutter that is movable between a first close position to close the delivery port and a first open position to open the delivery port; and
a second shutter that is arranged at a position farther from the delivery port than the first shutter in a delivery direction in which the toner is delivered from the delivery port and is movable between a second close position to close the delivery port and a second open position to open the delivery port.

2. The toner container according to claim 1, further comprising
a retaining member that is mounted on the container body and retains each of the first shutter and the second shutter in a movable state.

3. The toner container according to claim 1, further comprising
a shutter open/close mechanism that moves the first shutter from the first close position to the first open position and moves the second shutter from the second close position to the second open position when the toner container is attached to the attachment target part and that moves the first shutter from the first open position to the first close position and moves the second shutter from the second open position to the second close position when the toner container is detached from the attachment target part.

4. The toner container according to claim 3, wherein
the shutter open/close mechanism moves the second shutter to the second close position after the shutter open/close mechanism moves the first shutter to the first close position when the toner container is detached from the attachment target part.

5. The toner container according to claim 1, further comprising
a lock mechanism that fixes the first shutter at the first open position when the toner container is attached to the attachment target part and that cancels the fixation of the first shutter when the toner container is moved in a direction to be detached from the attachment target part.

6. The toner container according to claim 1, further comprising
a first seal member that is arranged between the first shutter and the delivery port and seals a gap between the first shutter and a peripheral edge of the delivery port.

7. The toner container according to claim 6, further comprising
a second seal member that seals a gap between the first shutter and the second shutter, wherein
a spacing between the first shutter and the first seal member in the thickness direction is less than or equal to a thickness of the second seal member.

8. The toner container according to claim 1, wherein
the second shutter has a recess portion recessed in a direction to be spaced away from the delivery port in the thickness direction, the toner container further comprising
a sheet member that is arranged at a peripheral edge of the recess portion and wipes off the toner.

9. An image forming apparatus, comprising:
a toner container according to claim 1;
an attachment target part to which the toner container is attached; and
a housing that houses the attachment target part.
